(19) United States
(12) Patent Application Publication
(10) Pub. No.: US 2025/0004518 A1
(43) Pub. Date: Jan. 2, 2025

(54) OPTIMAL CURRENT SELECTION METHOD FOR HYBRID PARALLEL INTEGRATED POWER SUPPLY

(71) Applicant: Wenzhou University, Wenzhou (CN)

(72) Inventors: Yuxing DAI, Wenzhou (CN); Zhenxing ZHAO, Wenzhou (CN); Zishun PENG, Wenzhou (CN); Wen HU, Wenzhou (CN); Fangying ZHU, Wenzhou (CN); Chun ZHANG, Wenzhou (CN)

(73) Assignee: Wenzhou University, Wenzhou (CN)

(21) Appl. No.: 18/624,065

(22) Filed: Apr. 1, 2024

(30) Foreign Application Priority Data
Jun. 30, 2023 (CN) 202310800641.4

(51) Int. Cl. G06F 1/26; H03K 17/567; H03K 17/687

(52) U.S. Cl. CPC G06F 1/26; H03K 17/567; H03K 17/687

(57) ABSTRACT

The present disclosure provides an optimal current selection method for a hybrid parallel integrated power supply, including the following steps: selecting multiple power device combinations with different current ratios, the combinations being formed by silicon insulated-gate bipolar transistor (Si IGBT) and silicon carbide metal-oxide-semiconductor field-effect transistor (SiC MOSFET) devices; comparing cost and junction temperatures on the Si IGBT devices and the SiC MOSFET devices under the different current ratios; comparing efficiency of a hybrid parallel integrated power supply with the different current ratios under different SiC MOSFET switching frequencies; comparing electromagnetic interference (EMI) noise of the hybrid parallel integrated power supply; selecting an optimal current ratio for the hybrid parallel integrated power supply.

### CROSS REFERENCE TO RELATED APPLICATION

This patent application claims the benefit and priority of Chinese Patent Application No. 202310800641.4, filed with the China National Intellectual Property Administration on Jun. 30, 2023, the disclosure of which is incorporated by reference herein in its entirety as part of the present application.

### TECHNICAL FIELD

The present disclosure relates to the field of power electronics, and in particular, to an optimal current selection method for a hybrid parallel integrated power supply.

### BACKGROUND

As the core component for energy conversion and system control of onshore power supply systems, inverters play a crucial role in determining the stability, reliability, and efficiency of the entire power supply system. Therefore, the research on high-power, high-performance, and cost-effective integrated power supplies is urgent. Silicon insulated-gate bipolar transistor (Si IGBT) and silicon carbide metal-oxide-semiconductor field-effect transistor (SiC MOSFET) are two power devices that serve as core elements of this hybrid parallel integrated power supply, and characteristics of these devices directly impact the performance of the hybrid parallel integrated power supply. The high capacity and low cost of Si IGBT inverter devices and the low loss, high switching frequency, and high harmonic suppression capability of SiC MOSFET inverters have gained widespread attention from scholars. However, there is still a lack of comprehensive theoretical research results on the current ratio of hybrid parallel inverters. The hybrid parallel integrated power supply also faces key technical challenges, such as the lack of research on the optimal current ratio for devices and immature power allocation optimization solutions.

The impact of different current ratios on device costs, junction temperatures, as well as the efficiency and electromagnetic interference (EMI) noise of the hybrid parallel integrated power supply is analyzed, aiming to select an optimal current ratio for the integrated power supply with a hybrid parallel topology.

In the prior art, Patent Publication No. CN110601523A entitled “Inverter, Control Method, and Computer Device” proposes a DC source, a half-bridge inverter topology, a low-pass filter, and a load that are sequentially connected. The half-bridge inverter topology includes hybrid devices, which include Si IGBT and high-frequency power devices connected in parallel. The high-frequency power devices include, but are not limited to, Si-based CoolMOS, SiC MOSFET, and gallium nitride high electron mobility transistor (GaN HEMT). This invention can avoid excessive working junction temperatures of power electronic devices and improve the service life of the inverters. However, unlike the present disclosure, it cannot reflect the advantages of the hybrid integrated power supply or meet the requirements for cost-effectiveness and high performance of the hybrid parallel integrated power supply.

### SUMMARY

To solve the above technical problems, the present disclosure provides an optimal current selection method for a hybrid parallel integrated power supply. The specific technical solution is as follows:

An optimal current selection method for a hybrid parallel integrated power supply is provided, including the following steps:
step S1: selecting multiple power device combinations with different current ratios, the combinations being formed by Si IGBT and SiC MOSFET devices;
step S2: performing a cost analysis on the Si IGBT devices and the SiC MOSFET devices under the different current ratios;
step S3: analyzing and comparing junction temperatures for the Si IGBT devices and the SiC MOSFET devices under the different current ratios;
step S4: comparing efficiency of the hybrid parallel integrated power supply with the different current ratios under different power levels and different SiC MOSFET switching frequencies;
step S5: comparing and analyzing EMI noise of the hybrid parallel integrated power supply and studying impact of the different current ratios on the EMI noise of the hybrid parallel integrated power supply;
step S6: studying impact of the different current ratios on device costs and junction temperatures as well as the efficiency and EMI noise of the hybrid parallel integrated power supply; and
step S7: selecting an optimal current ratio for the hybrid parallel integrated power supply.

Further, the current ratio in step S1 is defined as γ, and γ is a ratio of a rated current level of the Si IGBT device to a rated current level of the SiC MOSFET device at an operating condition of 100° C.:

$$γ = \frac{{i}_{\_ rating \_ IGBT} ( 100 ° C . )}{{i}_{\_ rating \_ MOS} ( 100 ° C . )} .$$

Further, step S2 specifically includes: summarizing data about current levels and device costs of the combinations of the Si IGBT devices and the SiC MOSFET devices, fitting the data into curves to obtain market trends, and conducting a comparative analysis.

Further, step S4 specifically includes: analyzing impact of the different current ratios on the efficiency of the hybrid parallel integrated power supply running at different power levels under a fixed SiC MOSFET switching frequency, and recording total device losses; and with a fixed power level of the hybrid parallel integrated power supply, increasing a SiC MOSFET operating frequency under the different current ratios, and analyzing impact of the SiC MOSFET operating frequency on the efficiency of the hybrid parallel integrated power supply.

Further, in step S5, power device rated currents used in the Si IGBT inverter and the SiC MOSFET inverter are the same, and the current ratio for the hybrid parallel integrated power supply is 1:1; EMI noise spectral amplitudes of the Si IGBT parallel inverter and the SiC MOSFET parallel inverter are compared within a specified resonance frequency range.

Further, step S5 specifically includes: increasing the current ratio from 1:1 to 4:1, comparing and analyzing noise voltage waveforms and spectral envelopes of the hybrid parallel integrated power supply, observing changes in turn-on ringing and turn-off ringing, and observing and comparing EMI noise spectral amplitudes within a specific frequency range.

Further, the following equations are solved:

$$\begin{matrix}Y = \frac{Δ cos t}{Pty Δη} & ( 1 - 1 ) \\ M = TPty Δη - Δ cos t & ( 1 - 2 )\end{matrix}$$

An incremental investment payback period Y (years) for the hybrid parallel integrated power supply under the different current ratios can be calculated using equation (1-1), that is, additional device costs can be recovered within Y years. An additional revenue M, in ¥, generated within a service life of the hybrid parallel integrated power supply can be calculated using equation (1-2), where P represents a power level of the hybrid parallel integrated power supply, in kW; t represents an annual average operational time of the hybrid parallel integrated power supply, in hours; y represents saved device loss costs, in ¥/W, as the current ratio decreases; Δcost represents a total device cost increase of the hybrid parallel integrated power supply, in ¥, as the current ratio decreases; T represents the service life of the hybrid parallel integrated power supply, and Δη represents a change in the efficiency of the hybrid parallel integrated power supply as the current ratio decreases.

The present disclosure has following beneficial effects:
1. The present disclosure selects various device combinations with different current ratios and applies these combinations to the hybrid parallel integrated power supply. The impact of the current ratios on device costs, device junction temperatures, as well as efficiency and EMI noise of the hybrid parallel integrated power supply is analyzed. The results show that as the current ratio increases, the total device cost decreases, the device junction temperature increases, the efficiency of the hybrid parallel integrated power supply decreases, and the EMI noise increases.
2. The present disclosure improves the efficiency without introducing significant EMI noise interference, confirming the superiority of the hybrid parallel integrated power supply.
3. The present disclosure calculates the differential investment recovery period and additional revenue for the hybrid parallel integrated power supply under different current ratios. It also takes into account the impact of the current ratio on device junction temperatures and EMI noise. An optimal current ratio of 2:1 is adopted, meeting the requirements for cost-effectiveness and high performance of the hybrid parallel integrated power supply.

### BRIEF DESCRIPTION OF THE DRAWINGS

FIG. 1 is a flowchart of an optimal current ratio selection method for a hybrid parallel integrated power supply;

FIG. 2 is a diagram depicting four power device combinations with different current ratios, the combinations being formed by Si IGBT devices and SCT-series SIC MOSFET devices;

FIG. 3 is a diagram showing total costs of Si IGBT and SiC MOSFET device combinations under four current ratios;

FIG. 4 is a comparison diagram of device losses and device junction temperatures for Si IGBT and SiC MOSFET devices under four current ratios;

FIG. 5 is a diagram showing efficiency of an integrated power converter under four different current ratios at power levels ranging from 1 kW to 7 kW; and

FIG. 6 depicts efficiency of an integrated power supply under four different current ratios, with a SiC MOSFET device at switching frequencies from 10 kHz to 60 KHz.

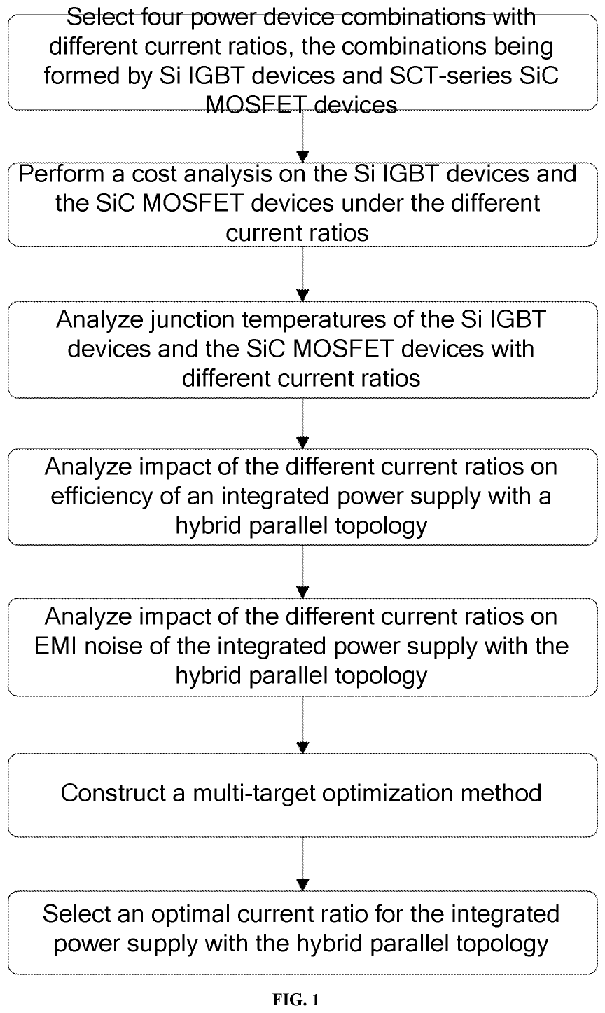

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts should fall within the protection scope of the present disclosure.

In the description of the present disclosure, it should be noted that terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “anticlockwise” and the like, are used to indicate orientations or position relationships shown in accompanying drawings. It should be noted that these terms are merely intended to facilitate a simple description of the present disclosure, rather than to indicate or imply that the mentioned apparatus or elements must have the specific orientation or be constructed and operated in the specific orientation. Therefore, these terms may not be construed as a limitation to the present disclosure.

In addition, the terms such as “first” and “second” are used only for descriptive purposes, and should not be construed as indicating or implying relative importance or implying the number of indicated technical features. Thus, features defined with “first” and “second” may explicitly or implicitly include one or more of the features. In the description of the present disclosure, “multiple” means two or more, unless otherwise specifically defined.

In the present disclosure, unless otherwise clearly specified and defined, meanings of terms “install”, “connect with”, “connect to” and “fixed to” should be understood in a broad sense. For example, the connection may be a fixed connection, a removable connection, or an integral connection, may be a mechanical connection or an electrical connection, may be a direct connection or an indirect connection via a medium, or may be intercommunication between two components.

Step S1: Select multiple power device combinations with different current ratios, the combinations being formed by Si IGBT devices and SCT-series SIC MOSFET devices. The current ratio is defined as γ, and γ is a ratio of a rated current level of the Si IGBT device to a rated current level of the SiC MOSFET device at an operating condition of 100° C.:

$$γ = \frac{{i}_{\_ rating \_ IGBT} ( 100 ° C . )}{{i}_{\_ rating \_ MOS} ( 100 ° C . )}$$

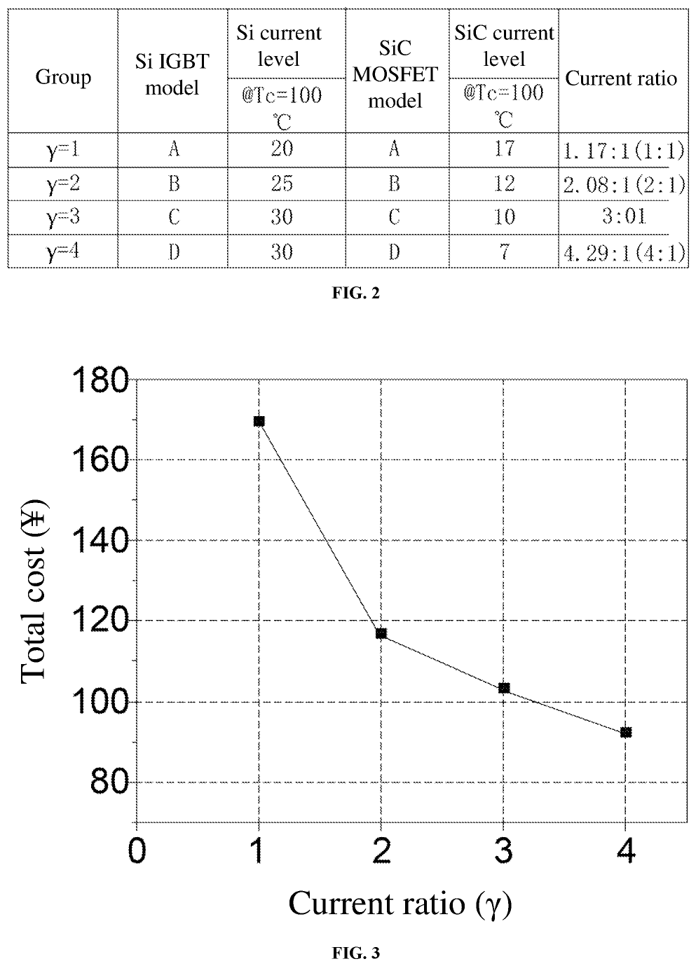

As shown in FIG. 2, this embodiment is illustrated using an example where the current ratios are 1:1, 2:1, 3:1, and 4:1, and the sum of rated currents of the Si IGBT devices and the SiC MOSFET devices approach 40 A.

Step S2: Perform a cost analysis on the Si IGBT devices and the SiC MOSFET devices under the different current ratios, summarize data about current levels and device costs of the combinations of the Si IGBT devices and the SiC MOSFET devices, fit the data into curves to obtain market trends, and conduct a comparative analysis, as shown in FIG. 3.

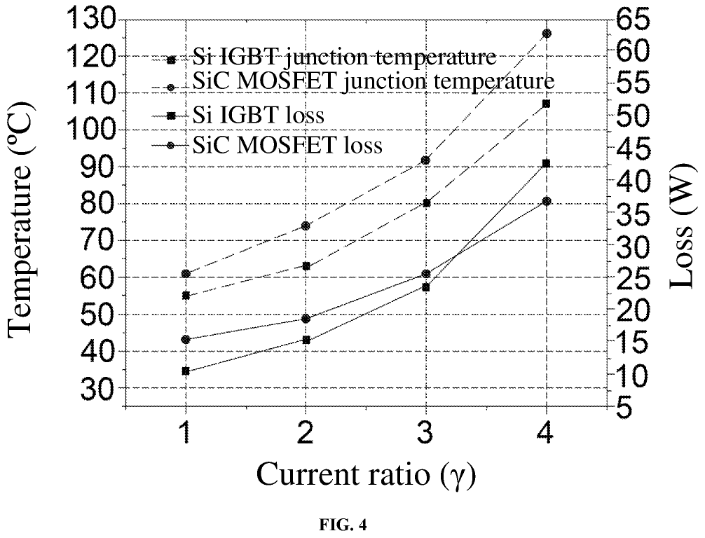

Step S3: Analyze and compare junction temperatures for the Si IGBT devices and the SiC MOSFET devices under the different current ratios. In this embodiment, experimental analysis is conducted at a power level of 6 kW and an operating frequency of 20 kHz. Junction temperatures of the Si IGBT devices and the SiC MOSFET devices with different current ratios are analyzed, with the current ratios being 1:1, 2:1, 3:1, and 4:1. Changes in device junction temperatures under different current ratios are observed. The maximum junction temperature not exceeding 126° C. is taken as an example for illustration, as shown in FIG. 4.

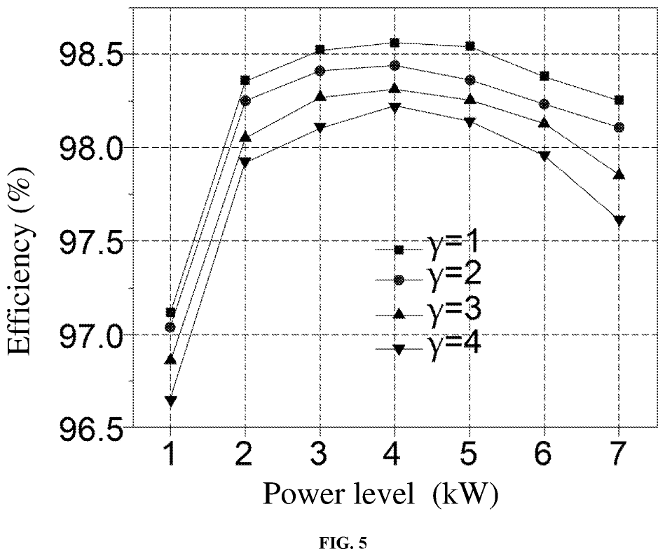

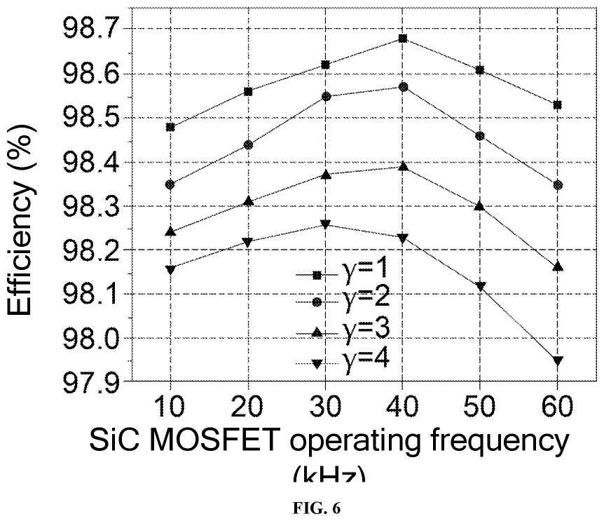

Step S4: Compare efficiency of the hybrid parallel integrated power supply with different current ratios under different power levels and different SiC MOSFET switching frequencies. As shown in FIG. 5, a specific method in this embodiment includes running the hybrid parallel integrated power supply at different power levels under a specified SiC MOSFET switching frequency, with the current ratios being set to 1:1, 2:1, 3:1, and 4:1, and analyzing the impact of the different current ratios on the efficiency of the hybrid parallel integrated power supply and recording total device losses; and as shown in FIG. 6, with a fixed power level of the hybrid parallel integrated power supply, increasing a SiC MOSFET operating frequency under different current ratios of 1:1, 2:1, 3:1, and 4:1, and analyzing impact of the SiC MOSFET operating frequency on the efficiency of the hybrid parallel integrated power supply.

Step S5: Compare and analyze EMI noise of the hybrid parallel integrated power supply and study impact of the different current ratios on the EMI noise of the hybrid parallel integrated power supply. Power device rated currents used in the Si IGBT inverter and the SiC MOSFET inverter are the same, and the current ratio for the hybrid parallel integrated power supply is 1:1; EMI noise spectral amplitudes of the Si IGBT parallel inverter and the SiC MOSFET parallel inverter are compared within a specified resonance frequency range.

In this embodiment, a method for studying the impact of the different current ratios on the EMI noise of the hybrid parallel integrated power supply includes: increasing the current ratio from 1:1 to 4:1, comparing and analyzing noise voltage waveforms and spectral envelopes of the hybrid parallel integrated power supply, observing changes in turn-on ringing and turn-off ringing, and observing and comparing EMI noise spectral amplitudes within a specific frequency range.

Step S6: Study impact of the different current ratios on device costs and junction temperatures as well as the efficiency and EMI noise of the hybrid parallel integrated power supply.

Step S7: Select an optimal current ratio for the hybrid parallel integrated power supply.

First, data about the efficiency and total device cost of the hybrid parallel integrated power supply under specified power levels and operating frequencies is collected. There exists an optimal current ratio that balances the economic benefits achieved by reducing device losses to improve the efficiency of the hybrid parallel integrated power supply, against the total investment cost incurred by increasing power devices. The hybrid parallel integrated power supply with the optimal current ratio has the highest cost-effectiveness, where the reduction in total power device losses in the hybrid parallel integrated power supply means an efficiency improvement of the system. This can shorten the incremental investment payback period and provide additional returns within the service life of the hybrid parallel integrated power supply.

The following equations are solved:

$$\begin{matrix}Y = \frac{Δ cos t}{Pty Δη} & ( 1 - 1 ) \\ M = TPty Δη - Δ cos t & ( 1 - 2 )\end{matrix}$$

An incremental investment payback period Y (years) for the hybrid parallel integrated power supply under the different current ratios can be calculated using equation (1-1), that is, additional device costs can be recovered within Y years. An additional revenue M, in ¥, generated within a service life of the hybrid parallel integrated power supply can be calculated using equation (1-2), where P represents a power level of the hybrid parallel integrated power supply, in kW; t represents an annual average operational time of the hybrid parallel integrated power supply, in hours; y represents saved device loss costs, in ¥/W, as the current ratio decreases; Δcost represents a total device cost increase of the hybrid parallel integrated power supply, in ¥, as the current ratio decreases; T represents the service life of the hybrid parallel integrated power supply, and Δη represents a change in the efficiency of the hybrid parallel integrated power supply as the current ratio decreases.

The present disclosure addresses the key technical challenges in the hybrid parallel integrated power supply, such as the lack of research on the optimal current ratio for devices and immature power distribution optimization solutions. The present disclosure provides a high-performance and cost-effective power supply solution by utilizing mixed power devices and adopting a high switching frequency, along with the construction of an integrated power supply experimental platform using parallel Si IGBT and SiC MOSFET inverters.

Preferred implementations of the present disclosure are described in detail above, but they should not be construed as a limitation on the scope of the present disclosure. It should be noted that various improvements and changes can be made by without departing from the concept of the present disclosure, and these improvements and changes shall fall within the protection scope of the present disclosure.

What is claimed is:

1. An optimal current selection method for a hybrid parallel integrated power supply, comprising:
step S1: selecting multiple power device combinations with different current ratios, the combinations being formed by silicon insulated-gate bipolar transistor (Si IGBT) and silicon carbide metal-oxide-semiconductor field-effect transistor (SiC MOSFET) devices;
step S2: performing a cost analysis on the Si IGBT devices and the SiC MOSFET devices under the different current ratios;
step S3: analyzing and comparing junction temperatures for the Si IGBT devices and the SiC MOSFET devices under the different current ratios;
step S4: comparing efficiency of the hybrid parallel integrated power supply with the different current ratios under different power levels and different SiC MOSFET switching frequencies;
step S5: comparing and analyzing electromagnetic interference (EMI) noise of the hybrid parallel integrated power supply and studying impact of the different current ratios on the EMI noise of the hybrid parallel integrated power supply;
step S6: studying impact of the different current ratios on device costs and junction temperatures as well as the efficiency and EMI noise of the hybrid parallel integrated power supply; and
step S7: selecting an optimal current ratio for the hybrid parallel integrated power supply.

2. The optimal current selection method for a hybrid parallel integrated power supply according to claim 1, wherein the current ratio in step S1 is defined as γ, and γ is a ratio of a rated current level of the Si IGBT device to a rated current level of the SiC MOSFET device at an operating condition of 100° C.:
$$γ = \frac{{i}_{\_ rating \_ IGBT} ( 100 ° C . )}{{i}_{\_ rating \_ MOS} ( 100 ° C . )} .$$

3. The optimal current selection method for a hybrid parallel integrated power supply according to claim 1, wherein step S2 specifically comprises: summarizing data about current levels and device costs of the combinations of the Si IGBT devices and the SiC MOSFET devices, fitting the data into curves to obtain market trends, and conducting a comparative analysis.

4. The optimal current selection method for a hybrid parallel integrated power supply according to claim 1, wherein step S4 specifically comprises: analyzing impact of the different current ratios on the efficiency of the hybrid parallel integrated power supply running at different power levels under a fixed SiC MOSFET switching frequency, and recording total device losses; and with a fixed power level of the hybrid parallel integrated power supply, increasing a SiC MOSFET operating frequency under the different current ratios, and analyzing impact of the SiC MOSFET operating frequency on the efficiency of the hybrid parallel integrated power supply.

5. The optimal current selection method for a hybrid parallel integrated power supply according to claim 1, wherein in step S5, power device rated currents used in the Si IGBT inverter and the SiC MOSFET inverter are the same, and the current ratio for the hybrid parallel integrated power supply is 1:1; EMI noise spectral amplitudes of the Si IGBT inverter and the SiC MOSFET inverter in parallel are compared within a specified resonance frequency range.

6. The optimal current selection method for a hybrid parallel integrated power supply according to claim 1, wherein step S5 specifically comprises: increasing the current ratio from 1:1 to 4:1, comparing and analyzing noise voltage waveforms and spectral envelopes of the hybrid parallel integrated power supply, observing changes in turn-on ringing and turn-off ringing, and observing and comparing EMI noise spectral amplitudes within a specific frequency range.

7. The optimal current selection method for a hybrid parallel integrated power supply according to claim 1, wherein the following equations are solved:
$$\begin{matrix}Y = \frac{Δ cos t}{Pty Δη} & ( 1 - 1 ) \\ M = TPty Δη - Δ cos t & ( 1 - 2 )\end{matrix}$$
wherein an incremental investment payback period Y (years) for the hybrid parallel integrated power supply under the different current ratios is calculated using equation (1-1), that is, additional device costs are recovered within Y years; an additional revenue M, in ¥, generated within a service life of the hybrid parallel integrated power supply is calculated using equation (1-2), wherein P represents a power level of the hybrid parallel integrated power supply, in kW; t represents an annual average operational time of the hybrid parallel integrated power supply, in hours; y represents saved device loss costs, in ¥/W, as the current ratio decreases; Δcost represents a total device cost increase of the hybrid parallel integrated power supply, in ¥, as the current ratio decreases; T represents the service life of the hybrid parallel integrated power supply, and Δη represents a change in the efficiency of the hybrid parallel integrated power supply as the current ratio decreases.
